(19) United States
(12) Patent Application Publication
(10) Pub. No.: US 2013/0205628 A1
(43) Pub. Date: Aug. 15, 2013

(54) Articles of manufacture and methods for efficient consumer identification of bottled medicines

(71) Applicant: Robert A. Nance, Indianapolis, IN (US)

(72) Inventor: Robert A. Nance, Indianapolis, IN (US)

(21) Appl. No.: 13/385,326

(22) Filed: Feb. 14, 2012

(51) Int. Cl. G09F 3/10; G09F 3/00

(52) U.S. Cl. 40/638; 40/299.01

(57) ABSTRACT

In order to better aid consumers of prescription medicine and the like in efficient and rapid identification of the correct pill to be taken from among multiple containers, a novel group of articles of manufacture adapted for use with end-use prescription medicine containers at least includes a plurality of predetermined medicine purpose types corresponding to different types of medical or vitality purposes that underlying medicines are targeted to treat or address. Each article of manufacture is adapted to be coupled to an end-use, target prescription medicine container by an end-user or pharmacy function, and each article of manufacture at least includes an ideogram adapted to encourage a psychological association with, and identification of, the medicine expected to be placed in the target prescription medicine container to which the article of manufacture is adapted, and each article of manufacture is associated with a particular medicine purpose type.

### BACKGROUND OF THE INVENTION

1. Field of the Invention

The present invention relates to schemes to aid patients and consumers in the post-manufacture identification of medicines and their associated containers, and in particular as relates to prescription medicines filled and prepared by pharmacies.

2. Background

Prescription medicine patients and consumers often must correctly choose between multiple prescription medicine containers to consume a required or suggested prescription medicine. It is common for prescription medicines to be placed in standard, confusingly similar containers—often with identical wall coloring and tops, and the same or similar bottle dimensions.

While pharmacy-obtained prescriptions certainly have the name of the medicines provided in the associated medicine containers, it is often not clear from a cursory inspection, the purpose of the prescription medicine (that is, the labels provided by the pharmacies often do not explain the ailment for which the medicine is to address). Whether conventional prescription pills are involved or other supplements (such as vitamins) and the like, the amount of confusion for a consumer increases as the number of contemporaneous prescriptions in effect for that consumer increases.

What is desirable but not addressed by the prior art, are inexpensive articles of manufacture and associated methods for enabling prescription medicine consumers to more rapidly and more easily identify medicines from among multiple prescription bottles without extensive reading or the need to understand complex pharmaceutical terms. What is also desirable but not addressed by the prior art is an inexpensive product and method for allowing consumers to efficiently distinguish from among multiple prescriptions after they have already received them from a pharmacy, or in the alternative, a product and method for allowing a pharmacy to provide medicine containers that will more easily facilitate container identification for the consumer.

Additionally, the prior art does not provide an inexpensive and effective product and method for identifying medicine containers in low-lighting conditions, or for consumers who are visually impaired.

### SUMMARY OF THE INVENTION

To address the unaddressed problems and limitations of the prior art, the present invention provides a novel group of articles of manufacture that are adapted for use with end-use prescription medicine containers. The novel group at least includes a plurality of predetermined medicine purpose types corresponding to different types of medical or vitality purposes that underlying medicines are targeted to treat or address. Each article of manufacture is adapted to be coupled to an end-use, target prescription medicine container by an end-user or pharmacy function, and each article of manufacture at least includes an ideogram adapted to encourage a psychological association with, and identification of, the medicine expected to be placed in the target prescription medicine container to which the article of manufacture is adapted, and each article of manufacture is associated with a particular medicine purpose type.

The invention also provides a novel method of identifying end-use prescription medicine containers. The method at least includes: providing a plurality of articles of manufacture adapted for use with end-use prescription medicine containers adapted to be coupled to an end-use, target prescription medicine container by an end-user or pharmacy function; grouping the articles of manufacture into a plurality of predetermined medicine purpose types corresponding to different types of medical or vitality purposes that underlying medicines are targeted to treat or address; providing on each article of manufacture, an ideogram adapted to encourage a psychological association with, and identification of, the medicine expected to be placed in the target prescription medicine container to which the article of manufacture is adapted; and associating each article of manufacture with a particular medicine purpose type.

### BRIEF DESCRIPTION OF THE DRAWING FIGURES

Features and advantages of the present invention will become apparent to those skilled in the art from the description below, with reference to the following drawing figures, in which:

FIG. 1 shows an exploded view of a prior art prescription medicine container/bottle;

FIG. 2 shows a plan view of the first embodiment of the present-inventive group of articles of manufacture in the form of a collection of printed labels according to the present invention;

FIG. 3 shows an enlarged view of a primary printed label and a supplemental printed label from FIG. 2;

FIG. 4 shows an exploded view of the printed labels of FIG. 3, and illustrates their placement onto a prescription medicine container/bottle;

FIG. 5 shows a top and side view of a second embodiment of an article of manufacture from the present-inventive group of articles of manufacture in the form of a medicine container top having printed matter thereon according to the present invention; and

FIG. 6 shows a top and side view of a third embodiment of an article of manufacture from the present-inventive group of articles of manufacture in the form of a medicine container top having a raised, molded portion corresponding to the printed matter of FIG. 5.

### DESCRIPTION OF THE PREFERRED EMBODIMENTS

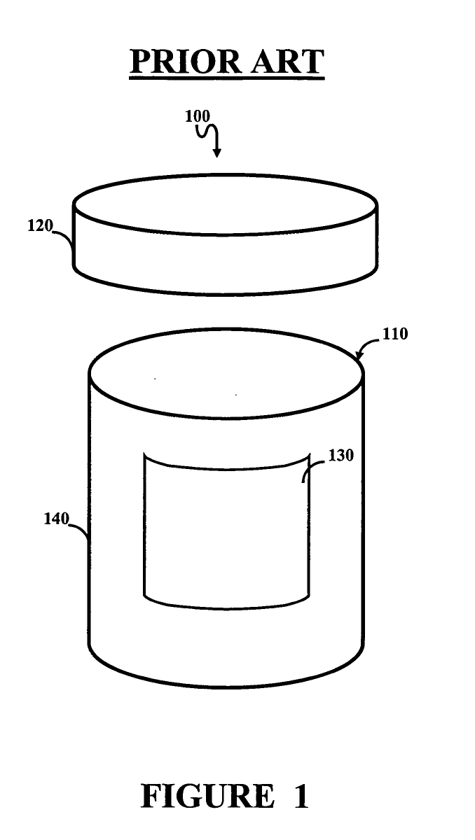

As a background, FIG. 1 shows a conventional prescription medicine container or bottle 100, as will be appreciated by those skilled in the art to which the present invention pertains. Such a container and top will also be readily familiar to those who have had prescription medicines. A container 110 is capable of storing pills, tablets, suppositories and the like for a patient's or consumer's use. The container 110 can also be in the form of a bottle capable of storing liquid form medicine and supplements. A top 120 can engage with the container 110 in a variety of ways, including applying a normal force coupled with a limited twisting motion to either open or close the top, and other methods, including counter-clockwise twisting (for opening) and clockwise twisting (for closing).

When obtained from a pharmacy, the medicine container typically includes a label 130 with the pharmaceutical name of the medicine in the container, the medicine's strength, and simple dosage instructions. Prescription containers may also include a label 140 (not shown) with additional information (e.g., “take with food,” “may cause drowsiness,” etc.).

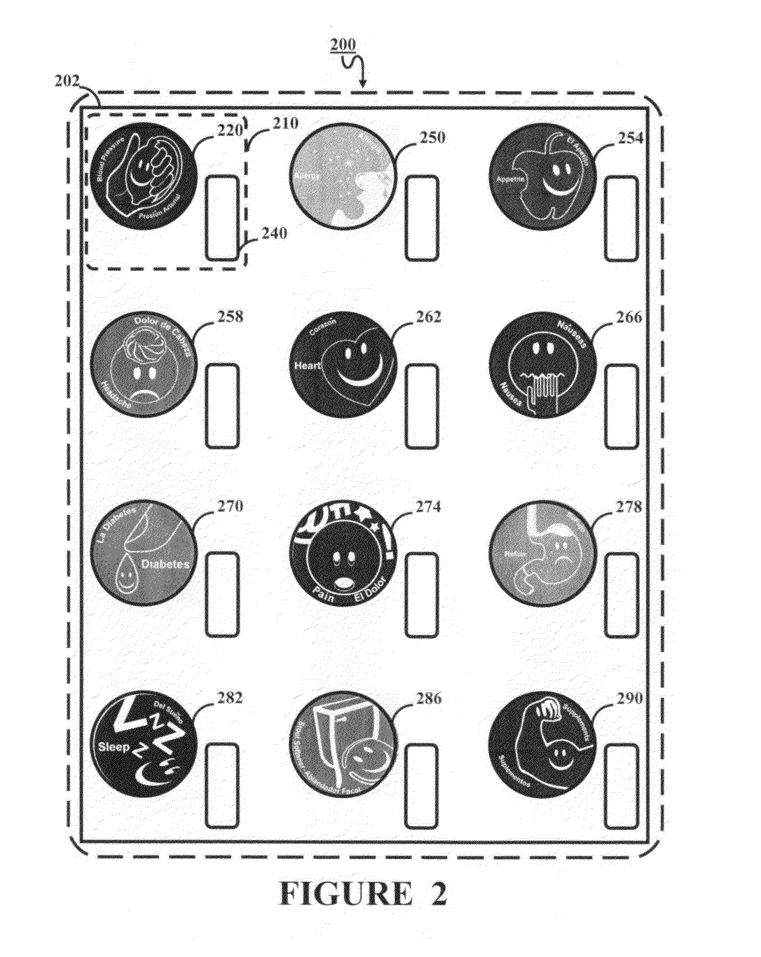

A first embodiment of the present-inventive collection or group of articles of manufacture 200 is illustrated in FIG. 2. The collection or group 200 has multiple articles of manufacture that are to be used to conveniently identify and distinguish among a plurality of medicine containers to solve the aforementioned prior art deficiencies. As will be evident from the description below, the articles of manufacture are designed to encourage a quick psychological connection with the medicine in, or to be placed in, the associated medicine container.

The articles of manufacture in FIG. 2 are in the form of printed labels adapted to be peeled for use from a sheet 202. In a preferred embodiment, subgroups 210 include a primary article of manufacture 220 adapted to identify the medicine container by way of the top, and a supplemental article of manufacture 240 adapted to be a supplemental information tag for the medicine container. The present invention does not, however, require the use of the supplemental articles of manufacture.

Each article of manufacture in the group 200 is directed to a predefined medicine purpose type. That is, the medicine purpose type corresponds to the intended use of the medicine. As an example, several adhesive articles of manufacture (printed labels in this case) 220, 250, 254, 258, 262, 266, 270, 274, 278, 282, 286, and 290 disclosed are capable of use with several medicine purpose types. In the example, the medicine purpose types which the labels are designed to distinguish when placed on the medicine container tops are: blood pressure; allergy; appetite; headache; heart; nausea; diabetes; pain; acid reflux; sleep; stool softening; and supplements (such as vitamins), respectively. The medicine purpose types are not limited to prescription medicines, and include, but are not limited to, over-the-counter medicines, other consumable health and vitality pills and liquids, suppositories and the like, and are not even strictly speaking limited to “medicines.”

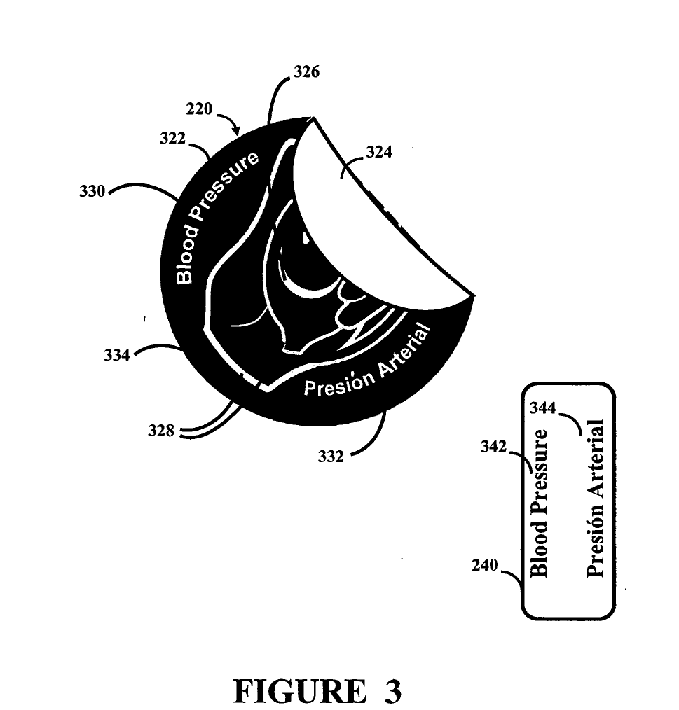

An example of the printed label (220) version of the present-inventive articles of manufacture is shown in FIG. 3. The label 220 has a printed side 322 and an adhesive side 324 to enable the label to be adhered or affixed to a medicine container top. A supplemental label 240 is also shown in the figure. In the particular example, the intended medicine purpose type is medicine intended to treat hypertension. Thus, the supplemental tag 240 includes the words “blood pressure” and its Spanish version “presión arterial.” The languages used on the present-inventive group of articles of manufacture are not limited to English and Spanish, or two in number.

Central to the function of articles of manufacture is an ideogram 326, for conveying non-verbal, suggestive information that implies an identity of the medicine included or to be included in the container for which a top is to be associated. This facilitates ease of distinguishing among multiple medicine containers by looking only at the tops. An additional feature of the articles of manufacture is luminescent (such as through phosphorescence) elements 328 for ease of identification in low-light conditions. The luminescent elements can match all the details of the ideogram 326 or fewer details as a matter of design choice.

The articles of manufacture also optimally include verbal description regions 330 and 332 for multilingual simple identification, and one or more Braille regions, to enable the visually impaired to utilize the present invention.

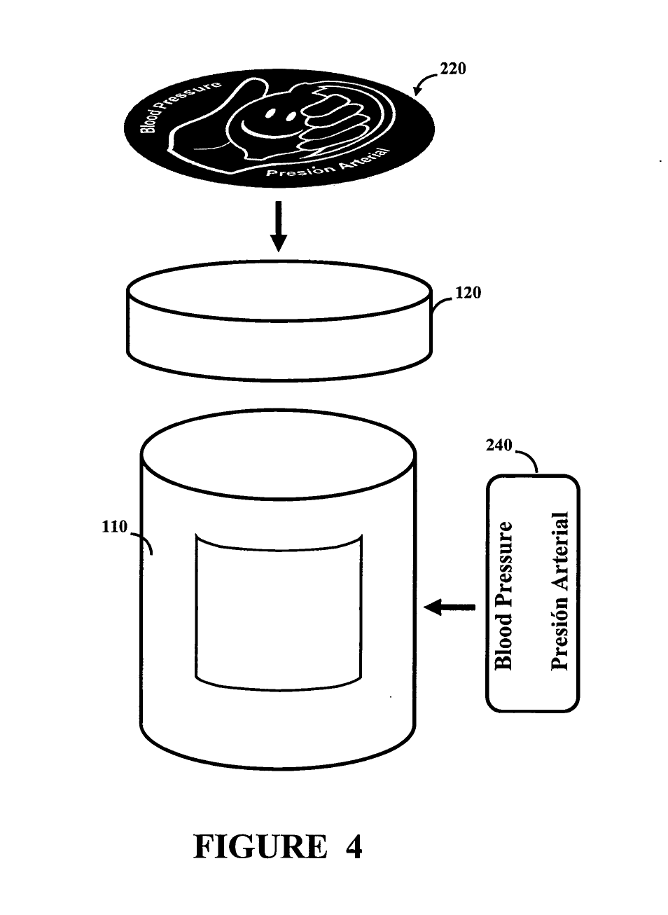

FIG. 4 shows the preferred positioning and application of the printed label version of the articles of manufacture on the medicine container top 120 and medicine container 110. The label/stickers 220 and 240 may utilize a variety of appropriate adhesives as will be understood by those skilled in the art.

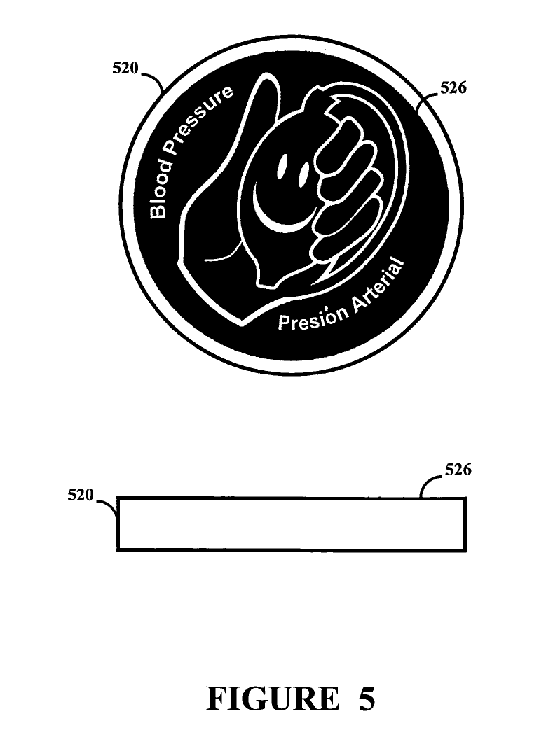

In a second, alternate embodiment of the present invention shown in FIG. 5, the articles of manufacture are not printed labels, but manufactured tops 520 with the ideogram and other aspects (526) of the labels printed directly on the tops via ink or color injection molding techniques. While not so limited, this version of the articles of manufacture may be specially suited for direct use by pharmacies and manufacturers. In addition to the ideogram, the tops 520 contain all of the elements of the printed label of FIG. 3.

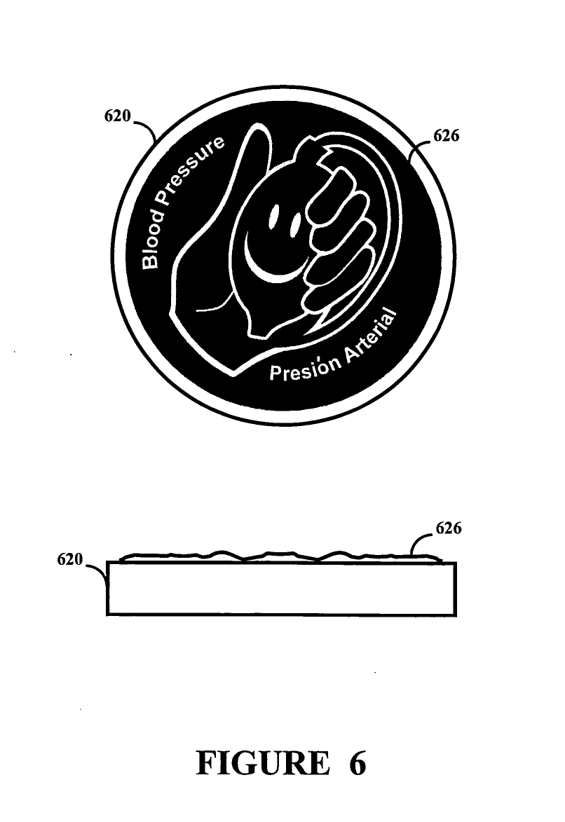

In yet a third, alternate embodiment of the present invention shown in FIG. 6, the articles of manufacture are molded medicine container tops 620. The ideogram and related portions of FIG. 3 (identified by the number 626 in the figure) are of the raised, molded variety, as can be seen from the side view of the medicine container top. The raised portion may be combined with ink to configure the necessary images, or the images may be molded directly. One advantage of the third embodiment shown in FIG. 6 over the second embodiment shown in FIG. 5 is the ease with which the Braille region can be formed.

Variations and modifications of the present invention are possible, given the above description. However, all variations and modifications which are obvious to those skilled in the art to which the present invention pertains are considered to be within the scope of the protection granted by this Letters Patent.

For example, articles of manufacture addressing many more medicine purpose types than the examples given may be contained in the present-inventive collection/groups. Also, alternative to providing a sheet with at least one of all of the different articles of manufacture in the group, multiple rolls of printed labels may comprise the group, wherein each roll is dedicated to a single kind of article of manufacture.

What is claimed is:

1. A group of articles of manufacture adapted for use with end-use prescription medicine containers, said group comprising:
a plurality of predetermined medicine purpose types corresponding to different types of medical or vitality purposes that underlying medicines are targeted to treat or address; and
each said article of manufacture adapted to be coupled to an end-use, target prescription medicine container by an end-user or pharmacy function, and each said article of manufacture comprising an ideogram adapted to encourage a psychological association with, and identification of, the medicine expected to be placed in the target prescription medicine container to which the article of manufacture is adapted, and each article of manufacture is associated with a particular medicine purpose type.

2. The group of articles of manufacture of claim 1, wherein said articles of manufacture comprise printed labels adapted for adherence to removable tops adapted to be operatively coupled to said prescription medicine containers.

3. The group of articles of manufacture of claim 1, wherein said articles of manufacture comprise removable tops adapted to be operatively coupled to said prescription medicine containers, and wherein an ideogram is printed onto a removable top.

4. The group of articles of manufacture of claim 1, wherein said articles of manufacture comprise removable tops adapted to be operatively coupled to said prescription medicine containers, and wherein an ideogram is molded onto a removable top.

5. The group of articles of manufacture of claim 1, wherein said articles of manufacture further comprise a verbal description of at least one word indicating the relevant medicine purpose type for which the article of manufacture is associated.

6. The group of articles of manufacture of claim 1, wherein said articles of manufacture further comprise at least a luminescent portion for low-lighting condition viewing of the ideogram.

7. The group of articles of manufacture of claim 1, wherein said articles of manufacture further comprise at least a Braille portion indicating the relevant medicine purpose type for which the article of manufacture is associated.

8. The group of articles of manufacture of claim 2, wherein each said label comprises a printed side and an adhesive side comprising an adhesive.

9. The group of articles of manufacture of claim 2, wherein each label is adapted to be adhered to the top of said prescription medicine container, and each label has at least one supplemental associated label adapted to be adhered elsewhere on said prescription medicine container.

10. The group of articles of manufacture of claim 2, wherein at least one label for each of the different medicine purpose types offered in a package to a consumer is printed on a single sheet of removable labels.

11. A method of identifying end-use prescription medicine containers comprising:
providing a plurality of articles of manufacture adapted for use with end-use prescription medicine containers adapted to be coupled to an end-use, target prescription medicine container by an end-user or pharmacy function;
grouping said articles of manufacture into a plurality of predetermined medicine purpose types corresponding to different types of medical or vitality purposes that underlying medicines are targeted to treat or address;
providing on each article of manufacture, an ideogram adapted to encourage a psychological association with, and identification of, the medicine expected to be placed in the target prescription medicine container to which the article of manufacture is adapted; and
associating each article of manufacture with a particular medicine purpose type.

12. The method of claim 11, wherein said articles of manufacture comprise printed labels adapted for adherence to removable tops adapted to be operatively coupled to said prescription medicine containers.

13. The method of claim 11, wherein said articles of manufacture comprise removable tops adapted to be operatively coupled to said prescription medicine containers, and further comprising:
printing an ideogram onto a removable top.

14. The method of claim 11, wherein said articles of manufacture comprise removable tops adapted to be operatively coupled to said prescription medicine containers, and further comprising:
molding an ideogram onto a removable top.

15. The method of claim 11, further comprising:
providing on each said article of manufacture, a verbal description of at least one word indicating the relevant medicine purpose type for which the article of manufacture is associated.

16. The method of claim 11, further comprising:
providing on each said article of manufacture, at least a luminescent portion for low-lighting condition viewing of the ideogram.

17. The method of claim 11, further comprising:
providing on each said article of manufacture, at least a Braille portion indicating the relevant medicine purpose type for which the article of manufacture is associated.

18. The method of claim 12, wherein each said label comprises a printed side and an adhesive side comprising an adhesive.

19. The method of claim 12, wherein each label is adapted to be adhered to the top of said prescription medicine container, further comprising:
for each label, providing at least one supplemental associated label adapted to be adhered elsewhere on said prescription medicine container.

20. The method of claim 12, further comprising:
providing at least one label for each of the different medicine purpose types offered in a package to a consumer on a single sheet of removable labels.
